(19) United States
(12) Patent Application Publication
(10) Pub. No.: US 2004/0153563 A1
(43) Pub. Date: Aug. 5, 2004

(54) Forward looking infrastructure re-provisioning

(76) Inventors: A. David Shay, Lawrenceville, GA (US); Michael S. Percy, Marietta, GA (US); Jeffrey G. Jones, Canton, GA (US)

Correspondence Address: Malvern U. Griffin III, SUTHERLAND ASBILL & BRENNAN LLP, 999 Peachtree Street, NE, Atlanta, GA, 30309-3996, US

(21) Appl. No.: 10/404,820

(22) Filed: Mar. 31, 2003

Related U.S. Application Data
(60) Provisional application No. 60/368,930, filed on Mar. 29, 2002.

(51) Int. Cl. G06F 15/16

(52) U.S. Cl. 709/232

(57) ABSTRACT

The present invention provides systems and methods for predicting expected service levels based on measurements relating to network traffic data. Measured network performance characteristics can be converted to metrics for quantifying network performance. The response time metric may be described as a service level metric whereas bandwidth, latency, utilization and processing delays may be classified as component metrics of the service level metric. Service level metrics have certain entity relationships with their component metrics that may be exploited to provide a predictive capability for service levels and performance. The present invention involves system and methods for processing metrics representing current conditions in a network, in order to predict future values of those metrics. Based on predicted service level information, actions may be taken to avoid violation of a service level agreement including, but not limited to, deployment of network engineers, re-provisioning equipment, identifying rogue elements, etc.

### CROSS-REFERENCE TO RELATED APPLICATIONS

This application claims benefit of co-pending U.S. Provisional Application No. 60/368,930, filed Mar. 29, 2002, which is entirely incorporated herein by reference. In addition, this application is related to the following co-pending, commonly assigned U.S. applications, each of which is entirely incorporated herein by reference: “Methods for Identifying Network Traffic Flows” filed Mar. 31, 2003, and accorded Publication No. ______; and “Systems and Methods for End-to-End Quality of Service Measurements in a Distributed Network Environment” filed Mar. 31, 2003, and accorded Publication No. ______.

### TECHNICAL FIELD

The field of the present invention relates generally to systems and methods for metering and measuring the performance of a distributed network. More particularly, the present invention relates to systems and methods for determining predicted values for performance metrics in a distributed network environment.

### BACKGROUND OF THE INVENTION

Network metering and monitoring systems are employed to measure network characteristics and monitor the quality of service (QoS) provided in a distributed network environment. In general, quality of service (QoS) in a distributed network environment is determined by fixing levels of service for performance of an application and the supporting network infrastructure. Examples of service level metrics include round trip response time, packet inter-arrival delays, and latencies across networks. By setting upper limit thresholds on performance levels, Service Level Agreements (SLA) can be derived that simultaneously benefit the application user community and can be met by the application and network service providers. While current network metering and monitoring systems are able to determine when a SLA has been violated, what is need is a system and method for predicting a SLA violation prior to the occurrence thereof. The ability to predict SLA violations would provide an opportunity to reprovision the network infrastructure in an attempt to avoid an actual SLA violation.

### SUMMARY OF THE INVENTION

The present invention provides systems and methods for predicting expected service levels based on measurements relating to network traffic data. Measured network performance characteristics can be converted to metrics for quantifying network performance. Certain metrics are functions of more than one measured performance characteristics. For example, bandwidth, latency, and utilization of the network segments, as well as computer processing time, all combine to govern the response time of an application.

The response time metric may be described as a service level metric whereas bandwidth, latency, utilization and processing delays may be classified as component metrics of the service level metric. Service level metrics have certain entity relationships with their component metrics that may be exploited to provide a predictive capability for service levels and performance. The present invention involves system and methods for processing metrics representing current conditions in a network, in order to predict future values of those metrics. Based on predicted service level information, actions may be taken to avoid violation of a service level agreement including, but not limited to, deployment of network engineers, re-provisioning equipment, identifying rogue elements, etc.

Additional embodiments, examples, variations and modifications are also disclosed herein.

### BRIEF DESCRIPTION OF THE DRAWINGS

FIG. 1 illustrates a simple linear regression model using periodic samples of a typical component metric.

FIG. 2 illustrates a least squares fit calculation for component metric sampled data.

FIG. 3 illustrates a multiple regression model for periodic samples of multiple component metrics.

FIG. 4 shows a least squares fit calculation for each component metric in the multiple regression model.

FIG. 5 illustrates a model for predicting a service level metric.

### DETAILED DESCRIPTION OF EXEMPLARY EMBODIMENTS

As mentioned, the quality of service (QoS) delivered in a distributed network environment can be determined by fixing levels of service for performance of an application and supporting network infrastructure. Examples of service level metrics include round trip response time, packet inter-arrival delays, and latencies across networks. By setting upper limit thresholds on performance levels, Service Level Agreements (SLA) can be derived that simultaneously benefit the application user community and can be met by the application and network service providers. The present invention provides systems and methods for early warning of possible SLA violations in order to permit re-provisioning of network resources. Re-provisioning of network resources in response to a predicted SLA violation will reduce the chance of an actual SLA violation.

The present invention operates in conjunction with a network metering and monitoring system that is configured to measure performance characteristics within a network environment and to convert such measured performance characteristics into metrics. Although the present invention may be used in connection with any suitable network metering and monitoring system, a preferred embodiment of the invention is described in connection with a system known as PerformanceDNA, which is proprietary to Network Genimics, Inc. of Atlanta Georgia. Broadly described, PerformanceDNA is a system for providing end-to-end network, traffic, and application performance management within an integrated framework. PerformanceDNA manages SLA and aggregated quality of service (AQoS) for software applications hosted on and accessed over computer networks.

Using PerformanceDNA, service level metrics can be monitored and measured in real time to report conformance and violation of the service level agreements. PerformanceDNA measures and calculates service level metrics directly by periodically collecting data at instrumentation access points (IAPs) strategically placed throughout a software applications' supporting network infrastructure. Certain aspects of the PerformanceDNA system are describe in greater detail in U.S. Patent Applications titled “Methods for Identifying Network Traffic Flows” and “Systems and Methods for End-to-End Quality of Service Measurements in a Distributed Network Environment,” both filed on Mar. 31, 2003, and assigned Publication Nos. ______ and ______, respectively.

Variation in measured samples of a typical service level metric (e.g. system state) are caused by measurement uncertainties and system uncertainties. Measurement uncertainty is governed by errors in the measurement itself and is referred to as ‘measurement noise.’ The system uncertainty is governed by random processes that perturb an otherwise constant system state (i.e. constant service level metric). The system uncertainty results from a wide variety of phenomena such as:

Collisions in multi-access protocol links

Error rates in the end-to-end transmission channel

Queueing delays for access to links and processors caused by congestion

Variable routes with variable bandwidth, queueing, and processing delays

Variable bytes transferred for bi-directional traffic

Availability of devices

Under ideal conditions, i.e., constant bandwidth with no congestion, no errors in the end-to-end transmission channel, a fixed number of bytes to be transferred in the bi-directional traffic, constant processing and switching speeds, etc., service level metrics can be calculated deterministically. However, application traffic on computer networks is never subject to ideal conditions. In general, it can be said that the system uncertainty results from the sum of many random variables, such as those listed above, whose distributions may or may not be known and are compounded by multiple users of the network infrastructure. The net result is to shift the service level metric of interest away from its ideal to a worse value and cause even more variation in the measured samples than that caused by the measurement noise. In addition, the same random processes may cause the service level metric of interest to exhibit a slope as it changes in response to changing conditions in the underlying network infrastructure.

In accordance with certain preferred embodiments of the present invention, time series analysis may be applied to the service level metrics collected by a network metering and monitoring system. Exemplary time series analysis techniques include, but are not limited to, an exponentially weighted moving average filter, Kalman filtering, or regression analysis. Applying time series analysis to a service level metric allows the trend of the service level metric to be monitored and used to derive the predicted next sample (PNS) of the metric. The PNS is then compared to definable thresholds in order to provide early warning of a potential SLA violation.

Some service level metrics that are measured directly are also functions of other measured performance characteristics. For example, the bandwidth, latency, and utilization of the network segments as well as the computer processing delays in the end-to-end path of an applications' transmitted and received packets will govern the round-trip response time of the application. While round-trip response time is a service level metric monitored, measured and reported by PerformanceDNA, the component metrics that govern response time are measured as well. Service level metrics may have entity relationships with component metrics, which are defined by weighted combinations of the component metrics. By monitoring the component metrics, performing time series analysis on them to get their PNS and weighting the importance of their contribution to the service level metric of interest, an early warning estimate of an SLA violation is derived.

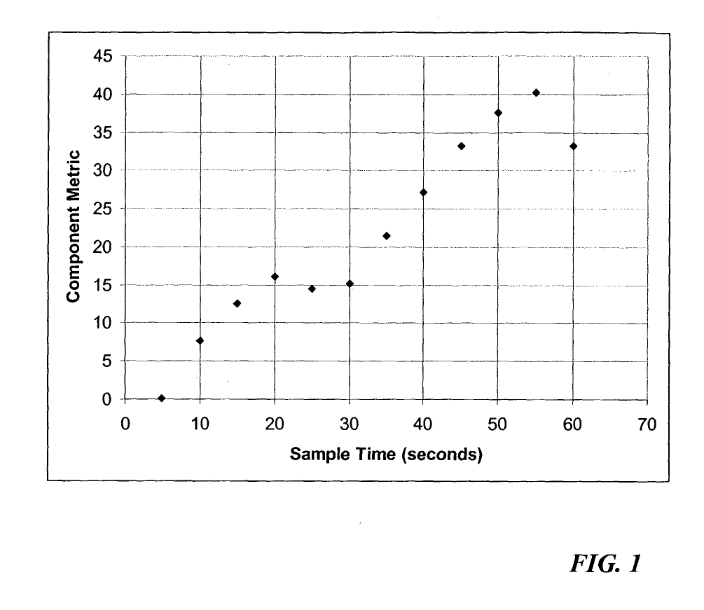

FIG. 1 illustrates a simple linear regression model using periodic samples of a typical component metric. From simple linear regression, an optimal form of the linear equation (1) may be determined based on the measured samples of a component metric, yᵢ, at times, xᵢ, with random errors, εᵢ:

yᵢ=β₀+β₁xᵢ+εᵢ, i=1, 2, . . . , n (1)

The random errors, εᵢ, typically are assumed to be normally distributed with zero mean and variance σ².

By minimizing the sum of the squares of the error term,

$${\sum }_{i = 1}^{n} {ϵ}_{i}^{2} ,$$

estimates of the regression coefficients, β₀ and β₁, can be derived and are given by:

\hat{β}₀=\overline{y}−\hat{β}₁\overline{x} (2)

$$\begin{matrix}{\hat{β}}_{1} = \frac{{\sum }_{i = 1}^{n} {y}_{i} {x}_{i} - \frac{( {\sum }_{i = 1}^{n} {y}_{i} ) ( {\sum }_{i = 1}^{n} {x}_{i} )}{n}}{{\sum }_{i = 1}^{n} {x}_{i}^{2} - \frac{{( {\sum }_{i = 1}^{n} {x}_{i} )}^{2}}{n}} & ( 3 ) \\ where \overline{y} = \frac{{\sum }_{i = 1}^{n} {y}_{i}}{n} & ( 4 ) \\ and \overline{x} = \frac{{\sum }_{i = 1}^{n} {x}_{i}}{n} & ( 5 )\end{matrix}$$

Estimates of the component metric, y, can be obtained at any value of x (time) over the interval of the regression. Predictions can be made beyond the interval with more uncertainty.

ŷ=\hat{β}₀+\hat{β}₁x (6)

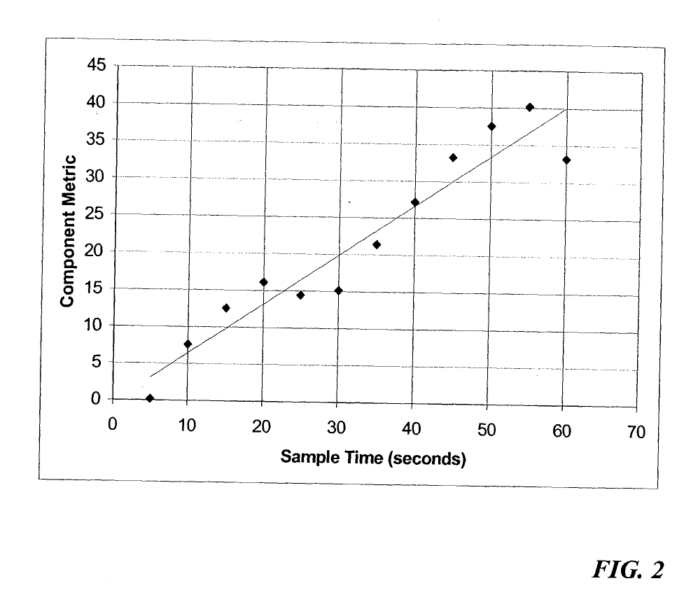

FIG. 2 illustrates a least squares fit calculation for component metric sampled data.

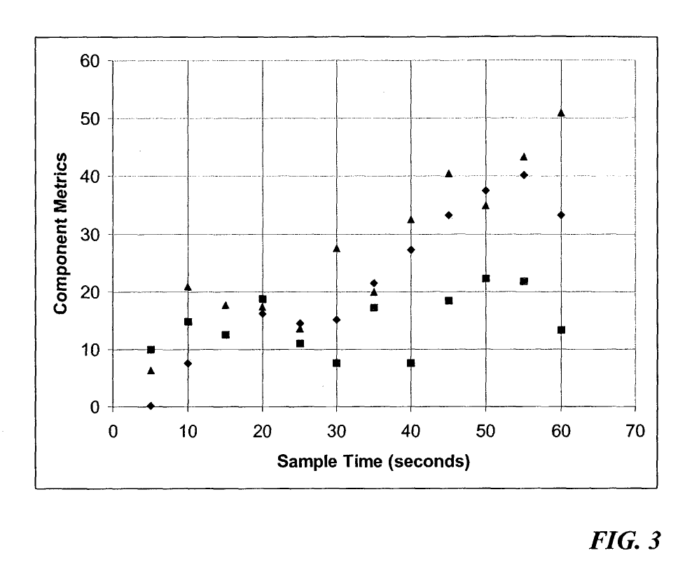

When multiple component metrics are involved, their equations may be estimated and used for multiple regression for the service level metrics of interest. FIG. 3 illustrates a multiple regression model for periodic samples of multiple component metrics. Using the same analysis as in simple linear regression model described above, for k different component metrics the model would have the following equations:

$$\begin{matrix}{\hat{y}}_{1} = {\hat{β}}_{01} + {\hat{β}}_{11} x \\ {\hat{y}}_{2} = {\hat{β}}_{02} + {\hat{β}}_{12} x \\ ⋮ \\ {\hat{y}}_{k} = {\hat{β}}_{0 k} + {\hat{β}}_{1 k} x\end{matrix} \qquad ( 7 )$$

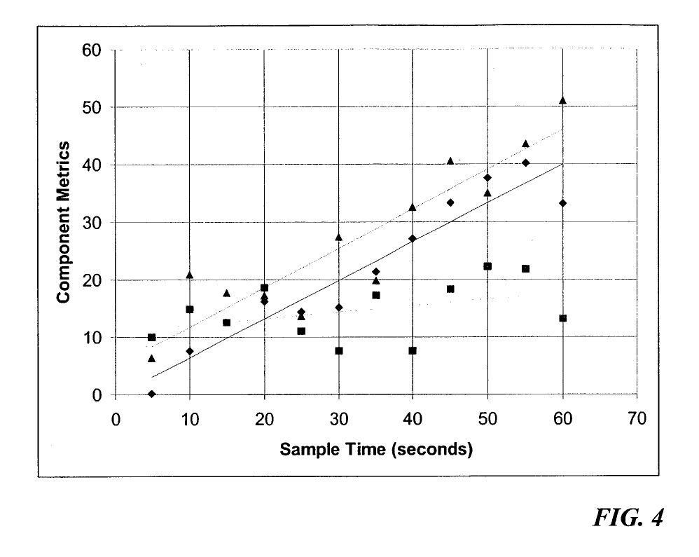

FIG. 4 shows a least squares fit calcualtion for each component metric in the multiple regression model.

Assume that measurements have yeilded j samples of a service level metric of interest at j different times within the regression interval (data collection interval), z₁,z₂, . . . , zⱼ, that is related to the component metrics. To find the relationship between the k component metrics, (7), and the service level metric of interest, z, the component metric estimates are needed at the same j sampling times as the service level metric samples. Therefore, the values of the k component metrics at the same j measurement times as the service level metric samples are sought.

| | component 1 | component 2 | | component k |
|---|---|---|---|---|
| Time 1 | ŷ₁₁ = \hat{β}₀₁ + \hat{β}₁₁x₁ | ŷ₁₂ = \hat{β}₀₂ + \hat{β}₁₂x₁ | . . . | ŷ₁ₖ = \hat{β}₀ₖ + \hat{β}₁ₖx₁ |
| Time 2 | ŷ₂₁ = \hat{β}₀₁ + \hat{β}₁₁x₂ | ŷ₂₂ = \hat{β}₀₂ + \hat{β}₁₂x₂ | . . . | ŷ₂ₖ = \hat{β}₀ₖ + \hat{β}₁ₖx₂ |
| . | . | . | | . |
| . | . | . | | . |
| . | . | . | | . |
| Time j | ŷⱼ₁ = \hat{β}₀₁ + \hat{β}₁₁xⱼ | ŷⱼ₂ = \hat{β}₀₂ + \hat{β}₁₂xⱼ | . . . | ŷⱼₖ = \hat{β}₀ₖ + \hat{β}₁ₖxⱼ (8) |

A multiple linear regression model can be formulated for the service level metric of interest, where j≧k+1, using the form:

$$\begin{matrix}{z}_{1} = {α}_{0} + {α}_{1} {\hat{y}}_{11} + {α}_{2} {\hat{y}}_{12} + … + {α}_{k} {\hat{y}}_{1 k} \\ {z}_{2} = {α}_{0} + {α}_{1} {\hat{y}}_{21} + {α}_{2} {\hat{y}}_{22} + … + {α}_{k} {\hat{y}}_{2 k} \\ ⋮ \\ {z}_{j} = {α}_{0} + {α}_{1} {\hat{y}}_{j1} + {α}_{2} {\hat{y}}_{j2} + … + {α}_{k} {\hat{y}}_{jk}\end{matrix} \qquad ( 9 )$$

Those skilled in the art will appreciate, however, that other multiple regression models are possible. For example a polynomial regression may best fit certain types of data.

Using matrix notation, where

$$\begin{matrix}Z = [ \begin{matrix}{z}_{1} \\ {z}_{2} \\ ⋮ \\ {z}_{j}\end{matrix} ] , & Y = [ \begin{matrix}1 & {\hat{y}}_{11} & {\hat{y}}_{12} & … & {\hat{y}}_{1 k} \\ 1 & {\hat{y}}_{21} & {\hat{y}}_{22} & … & {\hat{y}}_{2 k} \\ ⋮ & ⋮ & ⋮ & ⋮ & ⋮ \\ 1 & {\hat{y}}_{j1} & {\hat{y}}_{j2} & … & {\hat{y}}_{jk}\end{matrix} ] , & and & A = [ \begin{matrix}{α}_{0} \\ {α}_{1} \\ ⋮ \\ {α}_{k}\end{matrix} ] ,\end{matrix} \qquad ( 10 )$$

equation (9) becomes:

Z=YA (11)

The solution for the regression coefficients, α₁, α₂, . . . , αₖ, is given by:

Â=(Y′Y)⁻¹Y′Z (12)

At some future time, xₚ, an estimate of the service level metric of interest is given by:

\hat{z}=\hat{α}₀+\hat{α}₁ŷₚ₁+\hat{α}₂ŷₚ₂+ . . . +\hat{α}ₖŷₚₖ (13)ps

where

ŷ_{pq}=\hat{β}_{0q}+\hat{β}_{1q}xₚ and q=1, . . . , k. (b 14)

An estimate of the variance, \hat{σ}², of the service level metric of interest is given by:

$${\hat{σ}}^{2} = \frac{{\sum }_{i = 1}^{j} {e}_{i}^{2}}{j - k - 1} = \frac{{\sum }_{i = 1}^{j} {( {z}_{i} - {\hat{z}}_{i} )}^{2}}{j - k - 1} \qquad ( 15 )$$

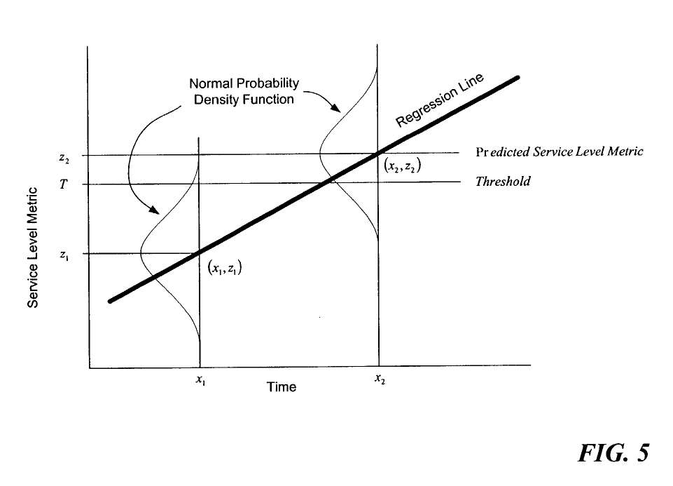

A probability may be assigned to the predicted service level metric of interest exceeding a certain threshold value, T, that represents a service level agreement. FIG. 5 illustrates a model for predicting a service level metric. The line in FIG. 5 that passes through the points (x₁,z₁) and (x₂,z₂) is the regression line for the service level metric of interest. The point (x₁,z₁) is the end of the regression interval used to model the service level metric and the point (x₂,z₂) is the predicted service level metric (PSLM). The actual value of the service level metric at time, x₂, will be normally distributed about the mean, z₂. The probability of the PSLM being below the threshold is the area under the normal probability density function from −∞ to T, i.e., Prob {Z≦T}. Therefore, the probability that the PSLM will exceed the threshold, T, is simply Prob{Z>T}=1−Prob{Z≦T}.

The normal probability density function (pdf) is given by,

$${f}_{Z} ( z ) = \frac{1}{\sqrt{2 π} {σ}_{\overline{z}}} {ⅇ}^{- \frac{{( z - \overline{z} )}^{2}}{2 {σ}_{\overline{z}}^{2}}} , \qquad ( 16 )$$

for which the cumulative distribution function is:

$${F}_{Z} ( z ) = {\int }_{- ∞}^{z} {f}_{Z} ( u ) ⅆ u = {\int }_{- ∞}^{z} \frac{1}{\sqrt{2 π} {σ}_{\overline{z}}} {ⅇ}^{- \frac{{( u - \overline{z} )}^{2}}{2 {σ}_{\overline{z}}^{2}}} ⅆ u . \qquad ( 17 )$$

$$Let w = \frac{u - \overline{z}}{{σ}_{\overline{z}}} ,$$

and substitute in order to derive the unit normal form of the pdf. Upon substituting w, we have

$${F}_{W} ( w ) = {\int }_{- ∞}^{w} \frac{1}{\sqrt{2 π}} {ⅇ}^{- \frac{{u}^{2}}{2}} ⅆ u , where \overline{w} = 0 and {σ}_{\overline{w}}^{2} = 1. \qquad ( 18 )$$

where \overline{w}=0 and σ_{\overline{w}}²=1.

This integral is given by:

F_{w}(w)=erf(w), (19)

where the error function, erf (w), is tabulated or approximated with a series expansion or polynomial function.

Now, the Prob{Z>T}=1−Prob{Z≦T} is

$$\begin{matrix}Now , the Prob \{ Z > T \} = 1 - Prob \{ Z \leq T \} is \\ = 1 - erf ( w ) where w = \frac{T - \overline{z}}{{σ}_{\overline{z}}} .\end{matrix} \qquad ( 20 )$$

When w>0, then the PSLM is below the threshold and therefore,

$$Prob \{ Z > T \} = 1 - erf ( \frac{T - \overline{z}}{{σ}_{\overline{z}}} ) . \qquad ( 21 )$$

When w<0, then the PSLM is above the threshold,

erf(−w)=1−erf(w). (22)

Therefore,

Prob{Z>T}=1−erf(−w). (23)

=1−(1−erf(w)) (24)

=erf(w) (25)

$$\begin{matrix}Prob \{ Z > T \} = 1 - erf ( - w ) . & ( 23 ) \\ = 1 - ( 1 - erf ( w ) ) & ( 24 ) \\ = erf ( w ) & ( 25 ) \\ = erf ( \frac{T - \overline{z}}{{σ}_{\overline{z}}} ) & ( 26 )\end{matrix}$$

In equations (21) and (26):

T is a constant>0 provided by a service level agreement,

\overline{z} is the predicted service level metric computed by the algorithm in equation (13) at any fixed time beyond the regression interval,

σ_{\overline{z}} is the standard deviation computed by the algorithm as the square root of equation (15).

The foregoing represents a closed form solution for predicting a future service level metric of interest as a function of measured component metrics and its probability of exceeding a given service level agreement, in accordance with preferred embodiments of the present invention. Additional closed form solutions may also be derived, as described above. The present invention provides one or more software modules for performing the above or similar calculations based on measured component metrics that are supplied by a network metering and monitoring system. Such software modules may be executed by a network server or other suitable network device. Generally, a software module comprises computer-executable instructions stored on a computer-readable medium. The software modules of the present invention may be further configured to provide a forward-looking mechanism that permits re-provisioning of a network infrastructure in the event of a predicted service level breach.

From a reading of the description above pertaining to various exemplary embodiments, many other modifications, features, embodiments and operating environments of the present invention will become evident to those of skill in the art. The features and aspects of the present invention have been described or depicted by way of example only and are therefore not intended to be interpreted as required or essential elements of the invention. It should be understood, therefore, that the foregoing relates only to certain exemplary embodiments of the invention, and that numerous changes and additions may be made thereto without departing from the spirit and scope of the invention as defined by any appended claims.

We claim:

1. A method for re-provisioning a network infrastructure, comprising:
monitoring performance metrics of a network component;
performing time series analysis on the metrics to obtain predicted next samples for each metric;
weighting and combining the predicted next samples to determine an estimated service level metric during a predictive period; and
determining a probability of whether the estimate of the service level metric will exceed a threshold value defined by a service level agreement.

2. The method of claim 1, wherein the performance metrics comprises at least one of bandwidth, latency, round-trip response time and utilization.

3. The method of claim 1, wherein the time series analysis comprises at least one of exponentially weighted moving average filter, Kalman filtering and regression analysis.

4. A method for re-provisioning a network infrastructure in an attempt to avoid a breach of a service level agreement, comprising:
receiving a plurality of measured component metrics, each of the measured component metrics having a weighted contribution to a service level metric;
applying a time series analysis to each of the plurality of measured component metrics so as to determine a predicted next sample for each of the plurality of measured component metrics;
combining each of the predicted next samples, based on the weighted contribution of each component metric to the service level metric, in order to determine an estimate of the service level metric during a prediction interval;
determining a probability of whether the estimate of the service level metric will exceed a threshold value defined by the service level agreement; and
if the probability exceeds a determined value, re-provisioning the network infrastructure prior to occurrence of the prediction interval.

5. The method of claim 4, wherein the performance metrics comprises at least one of bandwidth, latency, round-trip response time and utilization.

6. The method of claim 4, wherein the time series analysis comprises at least one of exponentially weighted moving average filter, Kalman filtering and regression analysis.
